(19) United States
(12) Patent Application Publication
(10) Pub. No.: US 2009/0290202 A1
(43) Pub. Date: Nov. 26, 2009

(54) HOLOGRAM RECORDING MEDIUM AND HOLOGRAM RECORDING/REPRODUCTION DEVICE

(76) Inventors: Tetsuro Mizushima, Osaka (JP); Kenichi Kasazumi, Osaka (JP); Tomoya Sugita, Osaka (JP); Kazuhisa Yamamoto, Osaka (JP); Shinichi Kadowaki, Hyogo (JP)

Correspondence Address: WENDEROTH, LIND & PONACK L.L.P., 1030 15th Street, N.W., Suite 400 East, Washington, DC, 20005-1503, US

(21) Appl. No.: 11/885,415

(22) PCT Filed: Feb. 24, 2006
(86) PCT No.: PCT/JP2006/303483

§ 371 Date: May 18, 2009

(30) Foreign Application Priority Data
Mar. 1, 2005 (JP) 2005-055680

(51) Int. Cl. G03H 1/02

(52) U.S. Cl. 359/3

(57) ABSTRACT

A hologram recording medium has a substrate and a hologram recording layer into or from which information is recorded or reproduced by a hologram, and a concavo-convex pattern having a reflection layer that transmits hologram recording/reproducing light and reflects light having a longer wavelength than the hologram recording/reproducing light is formed inside the hologram recording medium.

### TECHNICAL FIELD

The present invention relates to a medium into or from which information is recorded or reproduced using a holographic technique and a recording/reproduction device that enables recording or reproduction thereof.

### BACKGROUND ART

A compact disc (CD) is a recording medium that enables audio recording of 74 minutes of music data or recording of 650 MB of digital data using an optical system provided with a light source having a wavelength of 780 nm and an objective lens having a numerical aperture of 0.45. A digital versatile disc (DVD) is a recording medium that enables recording of 2 hours and 15 minutes of moving images in the MPEG2 method or 4.7 GB of digital data using an optical system provided with a light source having a wavelength of 650 nm and an objective lens having a numerical aperture of 0.6.

An expectation for a high-density and large-capacity optical disc has been increasing in recent years from triggers, such as broadcasting of high-resolution moving images at a 1000 lines of horizontal resolution or higher and enhanced performance of personal computers. Such being the case, an optical disc system or the like that combines a light source having a wavelength of about 400 nm and an objective lens having a numerical aperture of 0.85 is proposed and an optical disc achieving a recording capacity exceeding 20 GB per side is now achieved.

As described above, the optical disc device has been increasing the data recording density on a disc using a light source having a shorter wavelength and an objective lens having a larger numerical aperture. However, the approach to high-density recording by making the wavelength shorter and using a lens having a larger numerical aperture as described above is now reaching the limits. Hence, in order to further increase the data recording density on a disc, a holographic recording technique has been receiving considerable attention.

FIG. 9 is a view used to describe an example of a hologram recording/reproduction device adopting a conventional shift multiplex recording method proposed by Psaltis et al., and it schematically shows a configuration of an optical system in the hologram optical disc system (for example, Non-Patent Document 1).

A hologram recording/reproduction device 900 adopting the shift multiplex recording method shown in FIG. 9 has a laser light source 901 for hologram recording/reproducing light, a beam expander 907, a half mirror 908, a mirror 910, a spatial light modulator 902, Fourier transform lenses 903 and 904, a hologram recording medium 950, a collective lens 912, and a two-dimensional light receiving element array 906.

Light from the laser light source 901 for hologram recording/reproducing light, after the beam diameter thereof is expanded by the beam expander 907, is split into two beams by the half mirror 908. For one of the split beams, the traveling direction is changed by the mirror 910 to let the beam pass through the spatial light modulator 902. The beam having passed through the spatial light modulator 902 is collected by the Fourier transform lens 903, and the collected beam is irradiated on the hologram recording medium 950 as signal light 920. The other beam having passed through the half mirror 908 is collected by the collective lens 912. The other beam thus collected is irradiated on the hologram recording medium 950 as reference light 922 at the position same as the irradiation position of the signal light 920.

The spatial light modulator 902 has an optical switch array formed of two-dimensionally aligned optical switches and the respective switches come on and go off independently in response to an input signal 923. Each optical switch is a cell corresponding to one bit of image information. For example, the spatial light modulator 902 having 1024 cells×1024 cells is able to display 1 M bits of information at a time. When a light beam passes through the spatial light modulator 902, 1 M bits of information displayed on the spatial light modulator 902 is converted to a two-dimensional light beam array, which is collected by the Fourier transform lens 903.

When the recorded signal is reproduced, the reference light 922 alone is irradiated onto the hologram recording medium 950. Reproduction signal light 921, which is diffracted light from the hologram recording medium 950, is converted to a two-dimensional light beam array by passing through the Fourier transform lens 904. A reproduction signal 924 is outputted by irradiating this light beam array onto the two-dimensional light receiving element array 906.

The hologram recording/reproduction device 900 shown in FIG. 9 is characterized in that information can be multiplex-recorded because the hologram recording layer is as thick as about 1 mm and information is recorded as grating with thick interference fringes, that is, so-called Bragg grating. More specifically, because information is multiplex-recorded by changing the angle of incidence of the signal light or the reference light with respect to the hologram recording medium, it is possible to record a larger volume of information in a hologram recording medium. In the hologram recording/reproduction device 900 shown in FIG. 9, angular multiplex recording is achieved by shifting the irradiation position of reference light of spherical waves instead of changing an angle of incidence of the reference light 922. In other words, when the recording position is shifted in the medium traveling direction by slightly rotating the medium surface of the hologram recording medium 950, the angle of incidence of the reference light changes slightly and such a slight change is utilized for the multiplexing in hologram recording.

The hologram recording medium 950 as described above has a configuration in which a hologram recording layer encapsulating hologram media, such as photopolymers, is formed on the substrate, and interference fringes of the signal light 920 and the reference light 922 are recorded in the hologram recording layer.

However, when information is recorded or reproduced using a hologram, the wavefront reconstruction conditions are so strictly precise that an error of the angle of incidence or the position of the reference light readily deteriorates an output. Hence, it has been proposed to form markers, such as a concavo-convex pattern, on the substrate surface of a hologram recording medium for a servo and address detection of the hologram recording medium (for example, Patent Document 1).

Owing to the markers provided to the substrate, during recording, reference light and signal light interfere with each other at an appropriate position and at a higher degree of accuracy in the hologram recording layer, and interference fringes thus generated are recorded in the hologram recording layer. During reproduction, the markers are traced as a third laser beam spot called position control light is collected to the markers, which makes it possible to reproduce recorded data at a higher degree of accuracy.

As has been described, attention has been paid to the hologram recording medium as a large volume recording technique. However, there are many problems to be solved before it is put into practical use.

For a hologram recording medium having the concave-convex pattern as in Patent Document 1, it is necessary to prevent a loss in light amount resulting from reflection of hologram recording/reproducing light on the concavo-convex surface and exposure of the hologram recording layer to reflected light from the concave-convex surface. In addition, in a conventional multi-layer recording medium having a recording layer of the multi-layer structure, since a signal is detected on the focal plane of irradiated light, concave and convex portions on the surface on which neither recording nor reproduction is performed are defocused and generate no noises. In the case of a hologram recording medium, however, different from the conventional signal detection on the focal plane, recording/reproduction of multiplexed holograms is performed in the hologram recording layer having some thickness. This raises a need to remove wavefront noises generated on the concavo-convex surface.

Further, in order to multiplex information in the hologram recording medium, information is recorded not only by changing the angles of incidence of the signal light and the reference light, but also by moving the recording position. In such a case, a hologram information page is recorded while the hologram recording medium or the optical system is moving along the medium surface of the hologram recording medium. Hence, consideration also has to be given to the relation between the moving stroke and the concavo-convex pattern.

In addition, because a recording material different from those used in a conventional optical disc is used for the hologram recording medium, there arises a problem resulting from hologram media. In other words, the hologram media used in the hologram recording layer are made of photopolymers or the like using photopolymeric monomers or the like. Hence, the hologram recording layer readily undergoes a change in shape, such as an expansion and contraction, in response to recording and an environmental change, such as temperature and humidity. Accordingly, even when the concavo-convex pattern is formed on the substrate in advance as in Patent Document 1, this change in shape makes angular control of an angle of incidence of light difficult in the hologram recording/reproduction technique that requires precise control.

Apart from the foregoing, because the optical recording technique different from the one used for a CD, a DVD, or the like is adopted in the hologram recording technique, it is impossible to reproduce by a conventional recording/reproduction device. This raises an inconvenience that a hologram recording medium can be used only in a hologram recording/reproduction device. Also, it is desired for a recording/reproduction device to take into account compatibilities between a novel recording medium and a conventional recording medium.

Non-Patent Document 1: D. Psaltis, et al., “Holographic storage using shift multiplexing”, Optics Letters, Vol 20, No. 7, 782-784 (1995)

### Patent Document 1: JP 2002-63733 A

### DISCLOSURE OF THE INVENTION

The invention is to solve the conventional problems described above and therefore has an object to provide novel and useful hologram recording medium and hologram recording/reproduction device for use in large-volume information recording.

An aspect of the invention is a hologram recording medium having a substrate and a hologram recording layer into or from which information is recorded or reproduced by a hologram, in which a concavo-convex pattern is formed inside the hologram recording medium, and the concavo-convex pattern has a reflection layer that transmits hologram recording/reproducing light and reflects light having a longer wavelength than the hologram recording/reproducing light.

The above and other objects, features, aspects, and advantages of the invention will become more apparent from the following detailed description with reference to the accompanying drawings.

### BRIEF DESCRIPTION OF THE DRAWINGS

FIG. 1 is a cross section showing an example of a hologram recording medium according to a first embodiment of the invention.

FIG. 2 is a cross section showing another example of the hologram recording medium according to the first embodiment of the invention.

FIG. 3 is a plan view of a hologram recording medium according to a second embodiment of the invention when the medium surface is viewed from above.

FIG. 4 is a cross section showing an example of a hologram recording medium according to a third embodiment of the invention.

FIGS. 5A through 5C are cross sections showing another example of the hologram recording medium according to the third embodiment of the invention.

FIG. 6 is a cross section showing an example of a hologram recording medium according to a fourth embodiment of the invention.

FIG. 7 is a view schematically showing a configuration of a hologram recording/reproduction device according to the fourth embodiment of the invention.

FIG. 8 is a partially enlarged view of FIG. 7.

FIG. 9 is a view schematically showing a configuration of a conventional hologram recording/reproduction device.

### BEST MODE FOR CARRYING OUT THE INVENTION

### Embodiment 1

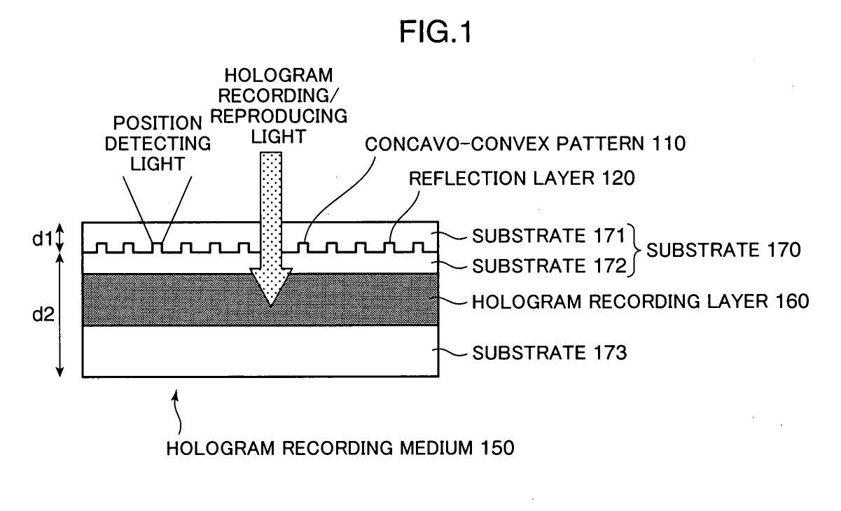

FIG. 1 is a cross section showing an example of a hologram recording medium according to the first embodiment of the invention. A hologram recording medium 150 has a substrate 170 formed of a substrate 171 and a substrate 172, a substrate 173, and a hologram recording layer 160 held between the substrate 170 and the substrate 173.

The hologram recording medium of this embodiment is provided with a concavo-convex pattern 110 inside the substrate 170 for recording servo information, position information used for position control, such as address information, and so forth. By forming such a concavo-convex pattern inside the hologram recording medium, the position information during recording or reproduction is detected at a higher degree of accuracy, which enables to perform recording and reproduction of a hologram in a stable manner. In addition, because the concavo-convex pattern is not formed on the outer surface of the substrate 170 of the light incident side, in a case where hologram recording/reproducing light is irradiated thereon, a phase shift caused by concave and convex portions or resulting from a difference in refractive index will not occur. In FIG. 1, although the concavo-convex pattern 110 is formed in a rectangular pattern of a certain length for ease of illustration, the shape thereof is not particularly limited as long as it is a pattern with which the position information can be detected. For example, a pit array, a groove pattern, or the like same as the concavo-convex pattern used for an optical disc can be used as well. Also, although the concavo-convex pattern 110 is formed inside the substrate 170 in FIG. 1, in a case where the substrate 172 is absent, the concavo-convex pattern may be formed between the hologram recording layer 160 and the substrate 171 or the concavo-convex pattern may be formed inside the substrate 173 of the side opposite to the light incident side.

In this embodiment, as long as the position information can be detected, the height of the concave and convex portions of the concavo-convex pattern is not particularly limited and it is normally 0.02 to 0.4 μm.

In the hologram recording medium of this embodiment, a reflection layer 120 that transmits hologram recording/reproducing light and reflects light having a longer wavelength than the hologram recording/reproducing light is provided on the concavo-convex pattern 110. By providing such a reflection layer, it is possible to lessen a loss in light amount resulting from reflection of the hologram recording/reproducing light on the concavo-convex surface, exposure of the hologram recording layer to reflected light from the concavo-convex surface, and noises on the concavo-convex surface.

A material of the reflection layer as described above is not particularly limited as long as it is a material that transmits the hologram recording/reproducing light and reflects light having a longer wavelength than the hologram recording/reproducing light. To be more concrete, one example is a multi-layer thin film made of a dielectric material, such as MgF₂, SiO₂, Al₂O₃, Y₂O₃, ZrO₂, TiO₂, and ZnS. Alternatively, a film of a cyanine- or azo-based organic pigment may be used according to a wavelength of position detecting light.

It is preferable that the reflection layer has reflectance of 1% or lower (transmittance of 99% or higher) for the hologram recording/reproducing light and reflectance of 10% or higher for the position detecting light. When the reflectance layer has the reflectance of 1% or lower for the hologram recording/reproducing light, noises resulting from reflection of the hologram recording/reproducing light on the interface between the substrate 171 and the substrate 172 and a power loss during the hologram recording/reproduction are reduced. When the reflection layer has the reflectance of 10% or higher for the position detecting light, the concavo-convex pattern can be readily detected with the position detecting light.

Also, it is preferable that the reflection layer has reflectance of 10% or higher for light having a wavelength slightly longer than that of the hologram recording/reproducing light, to be more specific, the light having a wavelength 10 to 50 nm longer than that of the hologram recording/reproducing light. When the reflection layer has the reflectance of 10% or higher, an effect to reduce the light exposure for the hologram recording layer can be achieved. More preferably, the reflectance for light having the wavelength specified above is 50% or higher. At the reflectance of 50% or higher, the light exposure reducing effect becomes noticeable.

The reflection layer is made of the material specified above by various film forming methods, such as vapor deposition, sputtering, and spin coating. For example, in a case where the concavo-convex pattern is formed inside the substrate, the substrate 171 having a concavo-convex pattern of a predetermined shape is formed first by means of injection molding or the like, and the reflection layer 120 is formed on the concavo-convex surface of the substrate 171 before the substrate 172 is formed, so that the substrate material of the substrate 172 is layered on the reflection layer 120 that has been formed earlier. Consequently, the substrate 170 in which the concavo-convex pattern 110 having the reflection layer 120 is internally formed is manufactured. In particular, in a case where the reflection layer is formed of a multi-layer thin film made by layering the dielectric material in a thickness of the order of a wavelength, the film configuration, such as the thicknesses of respective films of the dielectric material, is set according to the angle of incidence of the hologram recording/reproducing light and so forth.

In FIG. 1, the reflection layer is formed on the interface between the substrate 171 and the substrate 172. However, in a case where the substrate 172 is absent and the concavo-convex pattern is formed on the interface between the substrate 171 and the hologram recording layer 160, the reflection layer may be formed on the interface between the substrate 171 and the hologram recording layer 160. In this case, too, it is preferable that the reflection layer has reflectance of 1% or lower for the hologram recording/reproducing light and reflectance of 10% or higher for the position detecting light.

For recording/reproduction of the hologram recording medium as described above, in order to detect the concavo-convex pattern and to lessen an influence on the hologram recording/reproducing light, light having a longer wavelength than the hologram recording/reproducing light is used as the position detecting light. In a case where light having a wavelength of 550 nm or shorter, for example, the light having a wavelength of 532 nm, is used as the hologram recording/reproducing light, the light having a wavelength of 630 to 670 nm used for a DVD or the light having a wavelength of 770 to 820 nm used for a CD is preferable as the position detecting light when consideration is given to compatibilities described below among currently available light sources.

The concavo-convex pattern is detected by optically designing in such a manner that the focal position of the position detecting light is on the surface of the concavo-convex pattern. By focusing the position detecting light on the surface of the concavo-convex pattern, the position detection at a higher degree of accuracy is made possible by a fine concavo-convex pattern. In addition, because the concavo-convex pattern surface is the focal position, the position detection in the thickness direction is performed at the same time.

In the embodiment, the hologram recording layer 160 is a layer having recorded or capable of recording information by a hologram. The hologram recording layer of the embodiment is manufactured using conventionally known hologram media. To be more concrete, examples of the hologram media include a photopolymer material using photopolymeric monomers, an inorganic photorefractive material, such as LiNbO₃, an organic photorefractive material, such as carbazole-based material, and a liquid crystal molecule material. A preferable thickness of the hologram recording layer is 0.2 mm or greater. A large volume of information can be recorded when the hologram recording layer has a thickness of 0.2 mm or greater.

A known substrate used in a conventional optical disc is used for the substrates 171 through 173. To be more concrete, for example, a substrate made of a resin material or a glass material that transmits the hologram recording/reproducing light is used. Of these materials, in order to prevent deformation of the hologram recording layer induced by heat or humidity, a material hardly absorbing moisture and having a thermal contraction coefficient and a thermal expansion coefficient smaller than those of the hologram recording layer is preferable.

It is preferable that the substrate 172 and the substrate 173 have a refraction index with respect to the hologram recording/reproducing light almost equal to that of the hologram recording layer 160. When the refractive index of the both substrates and the refractive index of the hologram recording layer are almost equal, reflection of the hologram recording/reproducing light on the interfaces between the hologram recording layer and the respective substrates can be lessened. In a case where there is a difference in refractive index of these substrates, it is preferable to provide a coating separately on the interface(s).

A reflection preventing layer for the hologram recording/reproducing light may be provided on the outer surface of the hologram recording medium 150. For example, in the hologram recording medium of FIG. 1, the reflection preventing layer may be provided on the outer surfaces of the substrate 171 and the substrate 173.

In a case where the hologram reproducing light is read by a reflective type, reproducing light reflection films may be provided on the surface and in the inside of the substrate 173.

It is preferable that the substrate contains a material that absorbs light having a shorter wavelength than the hologram recording/reproducing light. Because the hologram media are readily exposed to light having a shorter wavelength than the hologram recording/reproducing light, use of the substrate containing an absorbing material having the characteristic as described above allows not only to improve the weather resistance, but also to suppress the occurrence of a change in shape resulting from exposure to light.

Such an absorbing material includes conventionally known light absorbing materials, and to be more concrete, examples include ketone-based or condensed ring-based organic materials, and inorganic materials, such as chalcogenide and titania. Alternatively, a material having an absorbing characteristic may be used as the material of the substrate per se.

In FIG. 1, the substrate 170 and the substrate 173 are respectively disposed on the both surfaces of the hologram recording layer 160. However, in a case where the protection layer or the like is formed on the hologram recording layer 160, it may be of a structure in which the substrate is disposed on the hologram recording layer 160 on one surface side alone. It should be noted, however, that the structure having the substrates on the both surfaces is preferable to suppress a change in shape of the hologram recording layer. In addition, the hologram recording layer 160 is not necessarily formed directly on the substrate 170 and the substrate 173, and another layer, such as a reflection preventing layer, may be provided therebetween.

It is preferable for the hologram recording medium of this embodiment to have an approximate symmetric structure in the thickness direction about the hologram recording layer 160. In other words, by holding the other configurations oppositely in almost the same thickness having the hologram recording layer 160 at the center, it is possible to lessen a change in shape of the hologram recording layer.

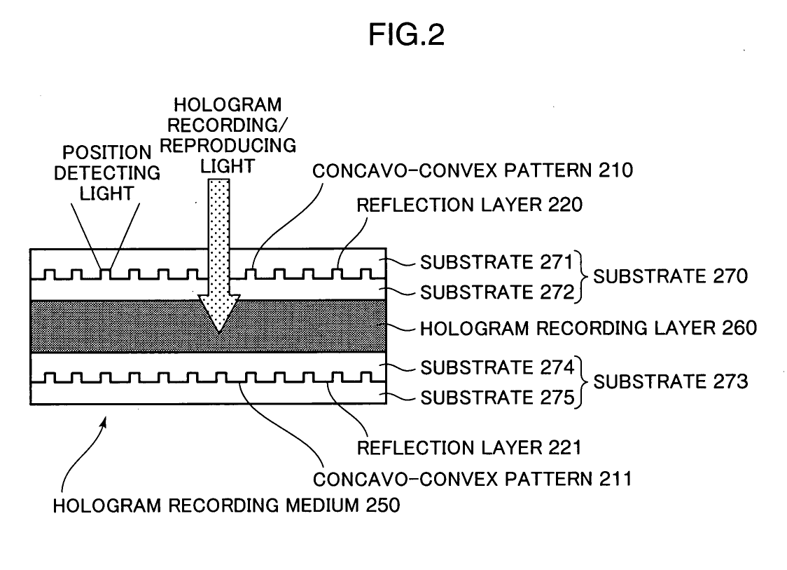

FIG. 2 is a cross section showing another example of the hologram recording medium of this embodiment. As with FIG. 1, a hologram recording medium 250 has a substrate 270, a substrate 273, and a hologram recording layer 260 held between these substrates.

The hologram recording medium 250 in FIG. 2 has concavo-convex patterns 210 and 211 on the substrate 270 and the substrate 273, respectively. A substrate 271 and a substrate 275 as well as a substrate 272 and a substrate 274 forming these substrates have almost the same thicknesses, and have an approximate symmetric structure in the thickness direction about the hologram recording layer 260. As the hologram recording medium has the approximate symmetric structure with respect to the thickness direction in this manner, in a case where the hologram recording layer 260 undergoes a change in shape, a shift can be decreased as an amount of deformation is made homogenous. As with FIG. 1, in the hologram recording medium 250 of FIG. 2, reflection layers 220 and 221 that transmit the hologram recording/reproducing light and reflect light having a longer wavelength than the hologram recording/reproducing light are formed, respectively, on these concavo-convex patterns 210 and 211 inside the substrate 270 and the substrate 273.

In addition, it is possible to prevent the hologram recording layer 260 from being exposed to light having a longer wavelength than the hologram recording/reproducing light by the both reflection layers 220 and 221.

It is preferable for the hologram recording medium of this embodiment that the contents information is recorded in the concave-convex pattern. The contents information referred to in the embodiment is different from information recorded in the hologram recording layer, and it is index information indicating the content recorded in the hologram recording layer, history information of the medium, and additional information, such as music and videos. When such contents information is recorded in the concave-convex pattern, the user is able to obtain the content of the recording medium and additional information, such as music and videos, without having to reproduce the hologram information per se.

A method of recording the contents information into the concavo-convex pattern is not particularly limited. For example, a method of manufacturing a concavo-convex pattern having specific recording pits by means of molding is used. Alternatively, it is possible to use a method of forming a recording layer of a pigment or the like used in a DVD or the like on the concavo-convex pattern and recording the contents information in this recording layer using specific recording light. In a case where the reflection layer is made of a pigment or the like, the reflection layer may be used as a recording layer to record the contents information. When such a recording layer is formed, it is possible to add information unique to an individual recording medium after the medium is manufactured.

In a case where the contents information is recorded in the concavo-convex pattern as described above, it is preferable to form the concavo-convex pattern at a position in a range of 0.55 mm to 0.65 mm both inclusive or a position in a range of 1.1 mm to 1.3 mm both inclusive from the surface of one side of the hologram recording medium.

By disposing the concavo-convex pattern in compliance with the DVD standards at the position having a distance in a range of 0.55 mm to 0.65 mm both inclusive (d1 or d2 of FIG. 1) from the surface of one side of the hologram recording medium, it is possible to reproduce information recorded in the concavo-convex pattern by a conventional DVD player. In order to facilitate the reproduction by a DVD player, preferable reflectance of the concavo-convex pattern is 15% or higher for light having a wavelength in a range of 630 to 670 nm.

Also, by disposing the concavo-convex pattern in compliance with the CD standards at the position having a distance in a range of 1.1 mm to 1.3 mm both inclusive (d1 or d2 of FIG. 1) from the surface of one side of the hologram recording medium, it is possible to reproduce information recorded in the concavo-convex pattern by a conventional CD player. In order to facilitate the reproduction by a CD player, preferable reflectance of the concavo-convex pattern is 15% or higher for light having a wavelength in a range of 770 to 820 nm.

By forming the concavo-convex pattern at the position specified above, as long as a hologram recording medium is formed so as to match the other configurations, such as the thickness of the medium, the contents information of the hologram recording medium is confirmed using a conventionally known recoding/reproduction device, such as a CD player and a DVD player.

### Embodiment 2

A hologram recording medium according to the second embodiment relates to an improvement when holograms are multiplex-recorded by shifting the medium and/or the optical system on the medium surface and thus by changing the recording position.

In the hologram recording/reproduction, one piece of pattern information generated by the spatial light modulator or received at the light receiving element is handled as one page of information unit. To be more specific, one page of information is two-dimensional data information handled in the spatial light modulator and the light receiving element, and the number of information bits per page is determined by the resolution of the spatial light modulator and the two-dimensional light receiving element, the coding condition, and so forth. During the hologram recording/reproduction, different pages are recorded/reproduced by changing the irradiation condition of the reference light from page to page. For this hologram recording/reproduction, in order to change the irradiation condition, the hologram recording medium and/or the optical system is moved to an adjacent hologram information page on the medium surface of the recording medium in some cases.

In the foregoing, the hologram recording/reproduction requires the position control at a higher degree of accuracy for a moving distance.

The hologram recording medium according to this embodiment is therefore designed in such a manner that the concavo-convex pattern detected by light having a longer wavelength than the hologram recording/reproducing light is formed on the surface and/or in the inside of the hologram recording medium and that the pitch of the concavo-convex pattern is smaller than a distance over which the hologram recording medium and/or the optical system is moved to the adjacent hologram information page on the medium surface of the hologram recording medium during recording or reproduction of a hologram.

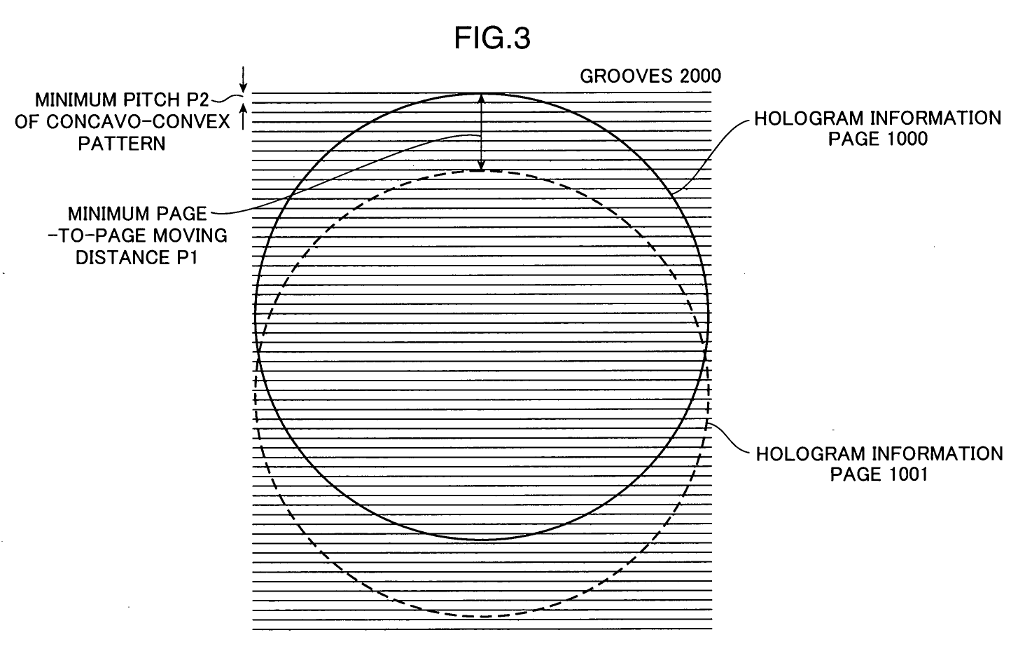

FIG. 3 is a plan view of the hologram recording medium of this embodiment when the medium surface is viewed from above, and it is a view showing an example of the relation of the concave-convex pattern and the hologram information page position. Referring to the drawing, a pattern of the parallel lines is grooves 2000 of the concavo-convex pattern, a circle indicated by a solid line is a hologram information page 1000, and a circle indicated by a broken line is an adjacent hologram information page 1001. The pitch of this concavo-convex pattern is indicated by P2 and a minimum moving distance (moving stroke) on the medium surface between the adjacent hologram information pages is indicated by P1. Herein, P1 is a distance over which the hologram recording medium and/or the optical system moves on the medium surface to record the adjacent hologram information page.

The hologram recording medium of this embodiment is formed in such a manner that one hologram information page bridges across the concavo-convex pattern. Also, it is designed in such a manner that an interval of the concavo-convex pattern and an interval between the adjacent hologram information pages satisfy the relation expressed as: P1>P2. In FIG. 3, the hologram information pages 1000 and 1001 are recorded to overlap each other; however, they do not necessarily overlap each other.

Because the concavo-convex pattern can be formed by means of injection molding or the like in a pattern of a shape having fewer errors, when the position information can be detected using the concavo-convex pattern having a pitch smaller than the moving stroke, the position control of the adjacent hologram information page is made possible at a higher degree of accuracy. Thus, it allows the reduction in errors of the moving stroke during the hologram recording/reproduction, which enables to achieve a large capacity and a higher degree of accuracy in the recording/reproduction at the same time.

The minimum moving distance over which the hologram recording medium and/or the optical system is moved to the adjacent hologram information page on the medium surface of the hologram recording medium is preferably three or more times longer than the pitch of the concavo-convex pattern. When it is three or more times longer, it enables almost exact hologram recording/reproduction. More preferably, the minimum moving distance is ten or more times longer than the pitch of the concavo-convex pattern. When the minimum moving distance is ten or more times of the pitch of the concavo-convex pattern, recording/reproduction is performed in a stable manner even in a case where the recording medium is moved and stopped repetitively.

In the hologram recording medium of this embodiment, the concavo-convex pattern may be formed on the surface of the hologram recording medium instead of being formed only in the inside thereof. This is because, even with a recording medium having the concavo-convex pattern on the surface thereof, errors of the moving stroke can be reduced by establishing the relation specified above.

### Embodiment 3

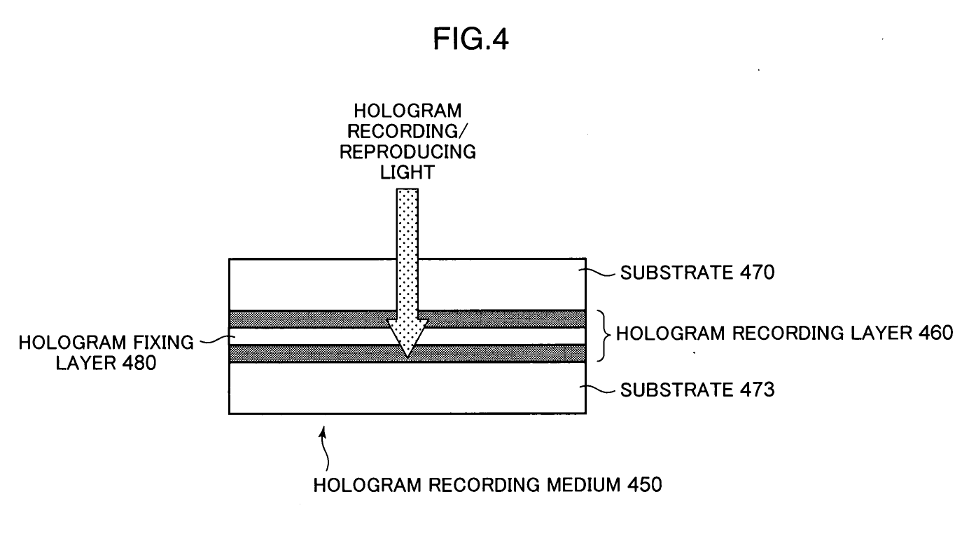

FIG. 4 is a cross section showing an example of a hologram recording medium according to the third embodiment of the invention. A hologram recording medium 450 has a substrate 470, a substrate 473, and a hologram recording layer 460 held between the substrate 470 and the substrate 473. The hologram recording medium of this embodiment has a hologram fixing portion 480 that suppresses a change in shape of the hologram recording layer inside the hologram recording layer 460.

Because a CD, a DVD, or the like as a conventional optical disc adopts a method of reading strength of reflected light on the pits as information, as long as light goes incident on predetermined pits, there will be no major problem in recording/reproduction even when the angle of incidence varies. However, because recording or reproduction is performed using an interference pattern of the signal light and the reference light for the recording/reproduction of a hologram, exact angle accuracy is required. Hence, when the hologram recording layer 460 undergoes a change in shape, such as in thickness, length, and warpage, under the environmental condition such as the temperature and the humidity, the recording condition, and so forth, such a change disturbs the hologram recording/reproduction. In particular, for the hologram recording layer containing, as the hologram media, photopolymers that record a hologram by exposing photopolymeric monomers to light and by solidifying, it is necessary to give consideration to a change in shape of the hologram media resulting from a change in condition.

In order to solve the problem above, in the hologram recording medium 450 of this embodiment, the hologram fixing portion 480 that transmits the hologram recording/reproducing light and suppresses a change in shape of the hologram recording layer is formed inside the hologram recording layer 460. By forming the hologram fixing portion 480 inside the hologram recording layer 460, even in a case where the hologram recording layer 460 is made of a material that readily undergoes a change in shape by an environmental change, under the recording condition, or the like, it is possible to lessen a shift of the hologram recording layer, which enables to perform recording/reproduction of a hologram at a higher degree of accuracy. In addition, because the hologram recording/reproducing light passes through the hologram fixing portion, recording/reproduction of a hologram will not be disturbed. It is preferable that the hologram fixing portion has reflectance of 1% or lower (transmittance of 99% or higher) for the hologram recording/reproducing light.

The hologram fixing portion is not limited to a particular material as long as it has an optical characteristic to transmit the hologram recording/reproducing light and a smaller amount of deformation in response to temperature, humidity, and so forth compared to that of the hologram recording layer in order to suppress a change in shape of the hologram recording layer. Preferable examples of the hologram fixing portion include a hologram fixing portion made of a resin material, a glass material, or the like having a thermal contraction coefficient and a thermal expansion coefficient smaller than those of the hologram recording layer. For example, in the case of a resin material, such a hologram fixing portion can be manufactured by ejection molding a low birefringent resin material such as polyolefin or by curing light- or thermo-curable resin such as acrylic and epoxy resin. In the case of a glass material, the hologram fixing portion may be manufactured by means of a forming process.

The hologram fixing portion may be formed from a material of the same type as that of the hologram media used in the hologram recording layer. By using the hologram fixing portion made of the hologram media, because the hologram fixing portion made of the material having the refractive index almost equal to that of the hologram recording layer is formed inside the hologram recording layer, an influence on the hologram recording/reproduction can be lessened. Examples of such a hologram fixing portion include photopolymers made by solidifying photopolymeric monomers. For example, the hologram fixing portion made of hologram media is manufactured by separately forming photopolymers solidified more than the hologram media of the hologram recording layer by heat and/or UV-irradiation, and by disposing the solidified photopolymers inside the hologram recording layer.

It is preferable to suppress a change in shape of the hologram recording layer 460 by the hologram fixing portion 480 to a greater extent, because a shift resulting from a change in shape of the hologram recording layer can be lessened further. In terms of exact angular control, a hologram fixing portion that suppresses a rate of change for a change in shape of the hologram recording layer to 0.1% or lower is preferable. The rate of change for a change in shape of the hologram recording layer means a rate of expansion or contraction change in the thickness direction of the hologram recording layer and a rate of expansion or contraction change in the in-plane direction. It is preferable that each rate of change is 0.1% or lower in response to a change in shape resulting from an environmental change or recording condition. The rate of change for a change in shape of the hologram recording layer is found by measuring the shape (thickness, length, and warpage). Alternatively, the rates of change in the thickness and in-plane directions may be found by measuring an angle and an interval of interference fringes of the hologram using diffracted light for hologram recording and comparing them with the angle and the interval before the change.

The hologram fixing portion 480 is not limited to a particular shape as long as it is of a shape capable of suppressing the change in shape of the hologram recording layer 460. In FIG. 4, the hologram fixing portion 480 is formed to have a layer structure inside the hologram recording layer 460. The hologram fixing portion 480, however, may be formed, for example, in the shape of a pillar inside the hologram recording layer 460. Such a pillar-shaped hologram fixing portion is manufactured by forming the hologram recording layer first, and then solidifying a part of the hologram media by exposing them to light via a specific photomask.

The hologram fixing portion of the layer structure is not limited to a particular thickness. However, in order to enhance the suppressing effect, the thickness in a range of 1/20 to ½ both inclusive of the thickness of the hologram recording layer is preferable. When the thickness of the hologram fixing portion is in a range of 1/20 to ½ both inclusive of the thickness of the hologram recording layer, the suppressing effect against an environmental change becomes noticeable.

A position at which the hologram fixing portion 480 is formed inside the hologram recording layer 460 is not particularly limited, either. However, in a case where the hologram fixing portion of the layer structure is formed, as is shown in FIG. 4, it is preferable that the hologram fixing portion 480 is disposed at the center portion of the hologram recording layer 460 in the thickness direction. When the hologram fixing portion 480 is disposed at the center portion of the hologram recording layer 480 in the thickness direction, changes in shape of the hologram recording layer at the top and bottom are suppressed homogeneously. In addition, as is shown in FIG. 4, it is preferable that the hologram recording medium 450 has an approximate symmetric structure in the thickness direction about the hologram fixing portion 480. In other words, in the hologram recording medium of FIG. 3, the hologram fixing portion 480 is disposed at the center portion of the hologram recording layer 460, and because the hologram recording layer 460 is sandwiched between the substrate 470 and the substrate 473 made of the same material and having the same thickness, it has an approximate symmetric structure in the thickness direction. As is shown in FIG. 4, by disposing the hologram fixing portion 480 of the layer structure at the center portion of the hologram recording layer 460, the change in shape of the hologram recording layer can be suppressed homogeneously, which can in turn suppress the change in shape of the hologram recording layer noticeably.

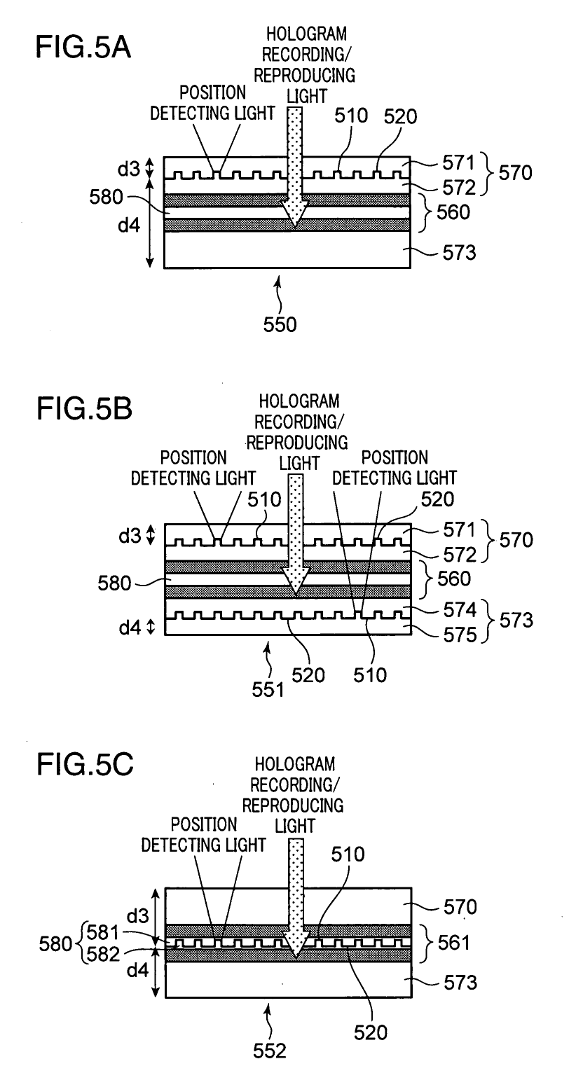

It is preferable for the hologram recording medium of this embodiment to have a concave-convex pattern inside the hologram recording medium. FIG. 5 is a cross section showing another example of the hologram recording medium of this embodiment. FIG. 5A shows a hologram recording medium in which a concave-convex pattern is formed inside the substrate on the light incident side. FIG. 5B shows a hologram recording medium in which concave-convex patterns are formed inside the substrates on the both sides. FIG. 5C is a case where the concave-convex pattern is formed inside the hologram fixing portion. By forming the concavo-convex pattern(s) inside the hologram recording medium, the position information during recording or reproduction is detected at a higher degree of accuracy, which enables to perform recording/reproduction of a hologram at a further higher degree of accuracy. In addition, because the concavo-convex pattern is formed inside the hologram recording medium and is not formed on the substrate surface on the light incident side, in a case where the hologram recording/reproducing light is irradiated thereon, a phase shift caused by the concave and convex portions or resulting from a difference in refractive index will not occur. For the shape of the respective concavo-convex pattern, the pattern same as the concavo-convex pattern described in the first embodiment above is used.

According to the hologram recording medium of FIG. 5A, because a hologram recording medium 550 has a hologram fixing portion 580 inside a hologram recording layer 560 and a concavo-convex pattern 510 inside a substrate 570, a change in shape of the hologram recording layer 560 is small. In addition, because the position information is detected by the concavo-convex pattern 510, the recording/reproduction position can be detected at a higher degree of accuracy.

Likewise, with the hologram recording medium of FIG. 5B, because a hologram recording medium 551 has concavo-convex patterns 510 on a substrate 570 and a substrate 573 on the both sides of a hologram recording layer 560, a change in shape of the hologram recording layer 560 is small. In addition, because the position information is detected by the concavo-convex patterns, the recording/reproduction position can be detected at a higher degree of accuracy.

Further, according to the hologram recording medium of FIG. 5C, because a concavo-convex pattern 510 is formed inside a hologram fixing portion 580 disposed inside a hologram recording layer 561 in a hologram recording medium 552, even when the hologram recording layer 561 undergoes a change in shape, a shift from the hologram fixing portion 580 is small. The recording/reproduction position can be therefore detected at a higher degree of accuracy.

Each concavo-convex pattern 510 as described above has a reflection layer 520 that transmits the hologram recording/reproducing light and reflects light having a longer wavelength than the hologram recording/reproducing light as described in the first embodiment above. By forming such a reflection layer, the position information can be detected at a higher degree of accuracy even when the concavo-convex pattern is present inside the hologram recording medium. As with the reflection layer of the first embodiment above, it is preferable that the reflection layer has reflectance of 1% or lower (transmittance of 99% or higher) for the hologram recording/reproducing light and reflectance of 10% or higher for the position detecting light.

The conventionally known manufacturing method of the substrate described in the first embodiment above is used as a manufacturing method of the substrates having the concavo-convex patterns of FIG. 5A and FIG. 5B. To manufacture the hologram fixing portion of FIG. 5C having the concavo-convex pattern in the inside thereof, in a case where the hologram fixing portion made of photopolymers is used, for example, a hologram fixing portion 581 having the concavo-convex pattern on one side is manufactured first by solidifying photopolymers using a die having a specific pattern by the same manufacturing method of the hologram fixing portion described above. Subsequently, the reflection layer 520 is formed on the hologram fixing portion 581 thus formed. The hologram fixing portion 582 is formed by further solidifying photopolymers on the reflection layer 520. The hologram portion 580 is thus obtained.

For the recording/reproduction of the hologram recording medium of this embodiment, as in the first embodiment, in order to lessen an influence on the hologram recording/reproducing light, detecting light having a wavelength different from that of the hologram recording/reproducing light is preferable as the position detecting light. In particular, in order to prevent deterioration of the hologram recording layer, light having a longer wavelength than the hologram recording/reproducing light is preferable. For example, in a case where light having a wavelength of 550 nm or shorter, for example, light having a wavelength of 532 nm, is used as the hologram recording/reproducing light, light having a wavelength of 630 to 670 nm used for a DVD or 770 to 820 nm used for a CD is preferable as the position detecting light when consideration is given to compatibilities with a currently available light source.

Further, in the hologram recording medium of this embodiment, in the case of a hologram recording medium having the concavo-convex pattern, it is preferable that the contents information is recorded in the concavo-convex pattern as in the first embodiment above. In a case where the contents information is recorded in the concave-convex pattern, it is preferable that the concavo-convex pattern is formed at a position in a range of 0.55 mm to 0.65 mm both inclusive or a position in a range of 1.1 mm to 1.3 mm both inclusive from the surface of one side of the hologram recording medium.

By disposing the concavo-convex pattern in compliance with the DVD standards at the position having a distance in a range of 0.55 mm to 0.65 mm both inclusive (d3 or d4 of FIGS. 5A through 5C) from the surface of one side of the hologram recording medium, it is possible to reproduce information recorded in the concavo-convex pattern by a conventional DVD player. In order to facilitate the reproduction by a DVD player, preferable reflectance of the concavo-convex pattern is 15% or higher for light having a wavelength in a range of 630 to 670 nm.

Also, by disposing the concavo-convex pattern in compliance with the CD standards at the position having a distance in a range of 1.1 mm to 1.3 mm both inclusive (d3 or d4 of FIGS. 5A through 5C) from the surface of one side of the hologram recording medium, it is possible to reproduce information recorded in the concavo-convex pattern by a conventional CD player. In order to facilitate the reproduction by a CD player, preferable reflectance of the concavo-convex pattern is 15% or higher for light having a wavelength in a range of 770 to 820 nm.

In addition, with the hologram recording medium of this embodiment, in the case of the hologram recording medium having the concavo-convex pattern, it is preferable, as in the second embodiment, that the pitch of the concavo-convex pattern is smaller than the distance over which the hologram recording medium and/or the optical system is moved to the adjacent hologram information page on the medium surface of the hologram recording medium during recording or reproduction of a hologram. When the position information is detected using the concavo-convex pattern having the pitch smaller than the moving stroke, exact position control on the medium surface is made possible. Errors of the moving stroke can be therefore reduced during the hologram recording/reproduction, which enables to achieve a large capacity and a higher degree of accuracy in recording/reproduction at the same time.

### Embodiment 4

A hologram recording medium according to the fourth embodiment has an object to achieve compatibilities with the conventional recording method.

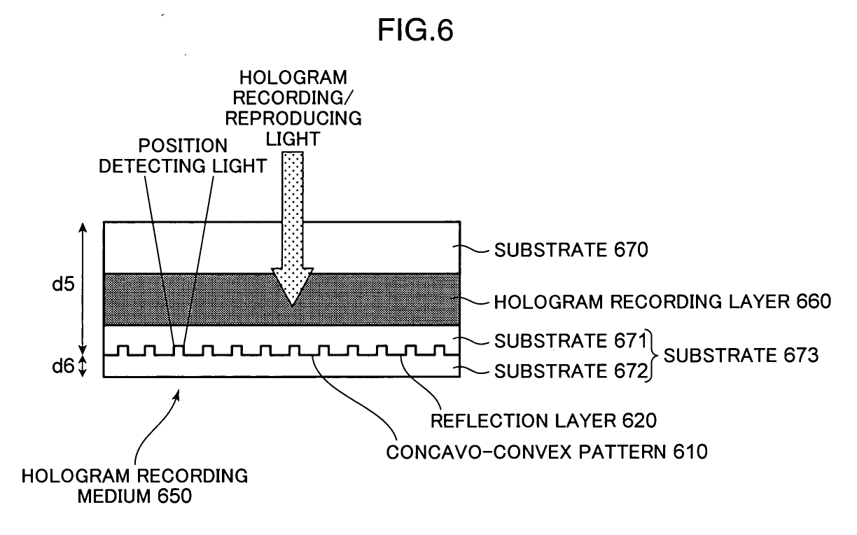

FIG. 6 is a cross section showing an example of the hologram recording medium according to the fourth embodiment. A hologram recording medium 650 has a substrate 670, a substrate 673, and a hologram recording layer 660 held between the substrate 670 and the substrate 673.

The hologram recording medium 650 of this embodiment has a concavo-convex pattern 610 inside the hologram recording medium (inside the substrate 673 in FIG. 6), and position information controlling recording or reproduction of information by a hologram and the contents information of the hologram recording medium are recorded in the concavo-convex pattern. The contents information is the information same as that in the first embodiment above. When such contents information is recorded in the concavo-convex pattern, the user is able to obtain the contents of the recording medium and additional information, such as music and videos, without having to reproduce the hologram information per se.

The concavo-convex pattern in the hologram recording medium of this embodiment may be provided with a reflection layer, as in the first embodiment above, that transmits the hologram recording/reproducing light. However, the reflection layer is not necessarily provided. Because there is a case where the reflective reproduction method is used for reproduction of a hologram, even with a concavo-convex pattern provided with a metal reflection film of silver, aluminum or the like that does not transmit the hologram recording/reproducing light as is the one used in a CD, a DVD, or the like, as long as the concave-convex pattern is formed on the side opposite to the light incident side of the hologram recording layer as is shown in FIG. 6, it is possible to obtain reflected light of the position detecting light, which makes it possible to reproduce information recorded in the concavo-convex pattern.

For the recording/reproduction of the hologram recording medium of this embodiment, in order to detect the concavo-convex pattern and lessen an influence on the hologram recording/reproducing light, detecting light having a wavelength different from that of the hologram recording/reproducing light is preferable as the position detecting light. In particular, in order to prevent deterioration of the hologram recording layer, light having a longer wavelength than the hologram recording/reproducing light is preferable.

Further, in the hologram recording medium of this embodiment, it is preferable that the concavo-convex pattern is formed at a position in a range of 0.55 mm to 0.65 mm both inclusive or a position in a range of 1.1 mm to 1.3 mm both inclusive from the surface of one side of the hologram recording medium.

By disposing the concavo-convex pattern in compliance with the DVD standards at the position having a distance in a range of 0.55 mm to 0.65 mm both inclusive (d5 or d6 of FIG. 6) from the surface of one side of the hologram recording medium, it is possible to reproduce information recorded in the concavo-convex pattern by a conventional DVD player. In order to facilitate the reproduction bya DVD player, preferable reflectance of the concavo-convex pattern is 15% or higher for light having a wavelength in a range of 630 to 670 nm.

Also, by disposing the concavo-convex pattern in compliance with the CD standards at the position having a distance in a range of 1.1 mm to 1.3 mm both inclusive (d5 or d6 of FIG. 6) from the surface of one side of the hologram recording medium, it is possible to reproduce information recorded in the concavo-convex pattern by a conventional CD player. In order to facilitate the reproduction by a CD player, preferable reflectance of the concavo-convex pattern is 15% or higher for light having a wavelength in a range of 770 to 820 nm.

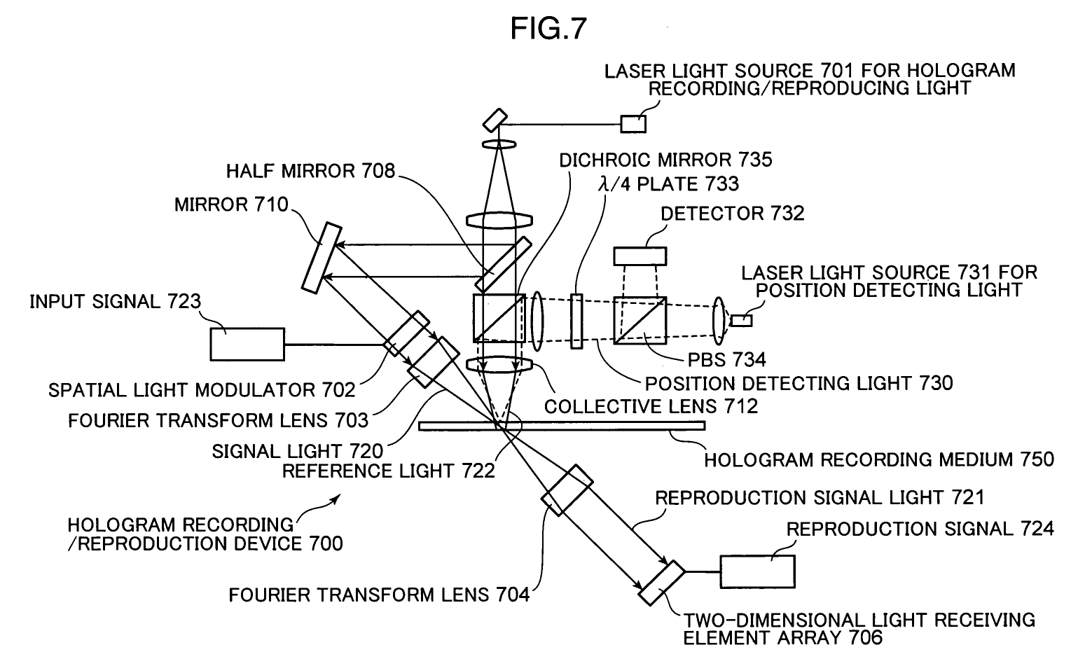

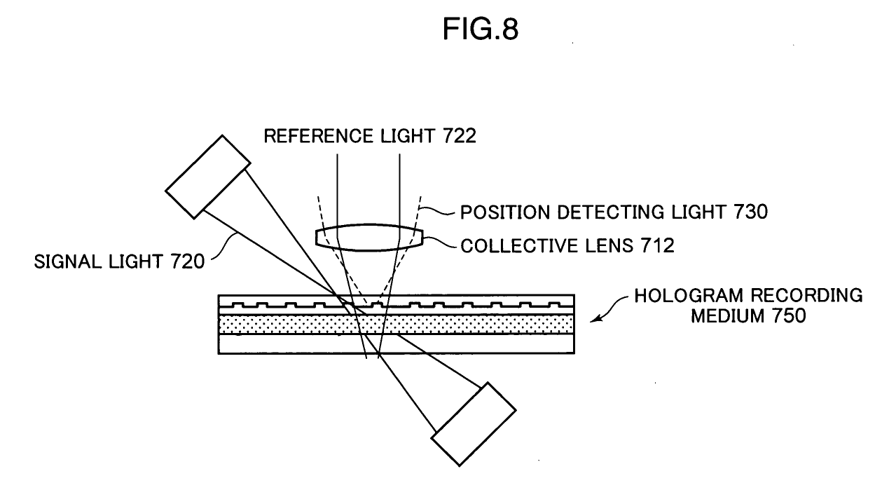

The hologram recording/reproduction device that enables recording/reproduction of the hologram recording medium of this embodiment will now be described. FIG. 7 is a schematic view of the hologram recording/reproduction device that enables recording or reproduction of the hologram recording medium of this embodiment. FIG. 8 is a partially enlarged view of FIG. 7.

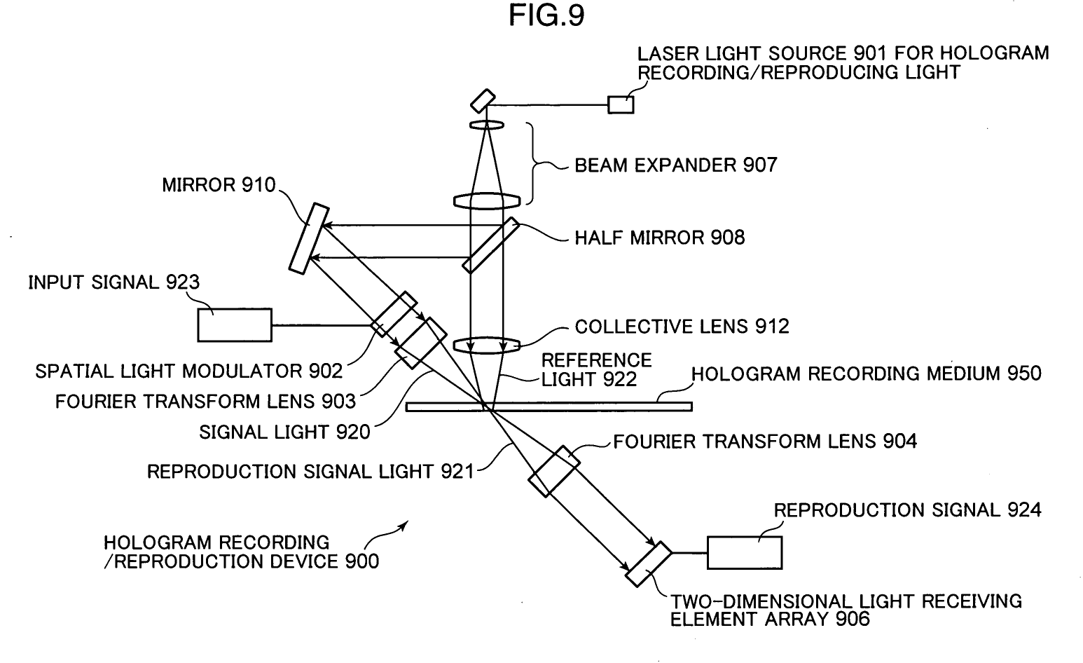

Descriptions of the configurations same as the configurations described with reference to FIG. 9 are omitted herein. The hologram recording/reproduction device of this embodiment has a first light source 701 for hologram recording/reproducing light that emits signal light and reference light for recording or reproducing a hologram, and a second laser light source 731 for position detecting light that emits position detecting light used to detect the position information and the contents information recorded in the concavo-convex pattern formed inside a hologram recording medium 750. Light having a longer wavelength than the hologram recording/reproducing light (reference light and signal light) is used as the position detecting light 730. For example, in a case where light having a wavelength of 532 nm is used as the hologram recording/reproducing light, light having a wavelength of 630 to 670 nm is used as the position detecting light.

Light emitted from the second laser light source 731 for position detecting light passes through a polarization beam splitter (PBS) 734 and merges with reference light 722 after the plane of polarization is adjusted by a λ/4 plate 733 and the traveling direction is bent by a dichroic mirror 735. The dichroic mirror 735 is an element that brings the reference light 722 and the position detecting light 730 to coaxial optical paths, and thin-film processing is applied on the surface thereof in such a manner that the reference light passes through it while the position detecting light 730 reflects on it according to a difference between the wavelength of the reference light 722 and the wavelength of the position detecting light 730.

The bent position detecting light 730 is collected on the concavo-convex pattern surface of the hologram recording medium 750 by the collective lens 712. As is shown in FIG. 8, in the hologram recording medium 750, the concavo-convex pattern is formed on the substrate positioned on the light incident side, and the reflection layer is formed on the concavo-convex pattern. This reflection layer has an optical characteristic of transmitting the hologram recording/reproducing light and reflecting the position detecting light. Hence, the light reflected on the concavo-convex pattern returns to the dichroic mirror 735 and is then reflected on the PBS 734 to reach a detector 732 as a signal to be detected.

Besides the detection of the position information recorded in the concavo-convex pattern, the detector 732 performs the position detection in the thickness direction of the hologram recording medium by the focal point detection method at the same time. The positions and the angles of the hologram recording medium and the optical system are controlled according to a signal obtained from the detector, which enables to perform the hologram recording/reproduction in a stable manner. In addition, in a case where the contents information signal is recorded in the concavo-convex pattern, the detector 732 detects the contents information signal from the concavo-convex pattern in addition to the position information. A known method used conventionally for a DVD or the like is used for reproduction of the position information and the contents information on the concavo-convex pattern. Examples of such a method include a method of forming the position information and the contents information at different positions on the concavo-convex pattern, a method of using the groove shape of the concavo-convex pattern for position information and the pits for the contents information, and so forth. In addition, in a case where the reflection layer is made of a pigment or the like, the contents information may be recorded in the reflection layer.

In FIG. 7, the position detecting light merges with the reference light and is guided to the hologram recording medium. However, the optical system is not necessarily disposed to a particular location as long as the position detecting light is collected on the concavo-convex pattern and the reflected light thereof is detected.

It is preferable for the hologram recording/reproduction device of this embodiment to use light having a wavelength of 630 to 670 nm as the position detecting light 730. Also, it is preferable to design the optical system for position detection by setting the focal point of the position detecting light in a range of 0.55 to 0.65 mm in the thickness direction from the surface of the hologram recording medium and the NA (numerical aperture) of the collective lens 712 in a range of 0.5 to 0.7. Under these design conditions, the hologram recording/reproduction device is able to reproduce not only the contents information signal of the hologram recording medium but also information of a disc in compliance with the DVD standards.

It is preferable for the hologram recording/reproduction device of this embodiment to use light having a wavelength of 770 to 820 nm as the position detecting light 730. Also, it is preferable to design the optical system for position detection by setting the focal point of the position detecting light in a range of 1.1 to 1.3 mm in the thickness direction from the surface of the hologram recording medium and the NA of the collective lens 712 in a range of 0.35 to 0.55. Under these design conditions, the hologram recording/reproduction device is able to reproduce not only the contents information signal of the hologram recording medium, but also information of a disc in compliance with the CD standards.

The hologram recording/reproduction device of this embodiment is also applicable to recording/reproduction of a hologram recording medium in another embodiment having a concavo-convex pattern in the inside thereof. In addition, it is also able to play back a conventional optical disc, such as a DVD, using the position detecting light.

In the embodiments above, the hologram recording medium has been described using a cross section thereof, whereas a planar shape thereof is not limited to a particular shape, and it can be in the shape of a disc, a card, and other shapes. It is sufficient for the hologram recording layer to be capable of recording/reproducing information using the holographic technique, and a recording medium can be of any of the read-only, write-once, and rewritable types.

As has been described, in one aspect of the invention, a hologram recording medium has a substrate and a hologram recording layer into or from which information is recorded or reproduced by a hologram, wherein a concavo-convex pattern is formed inside the hologram recording medium, and the concavo-convex pattern has a reflection layer that transmits hologram recording/reproducing light and reflects light having a longer wavelength than the hologram recording/reproducing light. According to this configuration, because the position information during recording or reproduction is detected at a higher degree of accuracy by the concavo-convex pattern, recording/reproduction of a hologram in a stable manner is achieved. In addition, because the concavo-convex pattern is not formed on the surface of the substrate on the light incident side, in a case where the hologram recording/reproducing light is irradiated thereon, a phase shift caused by concave and convex portions or resulting from a difference in refractive index will not occur. By providing the reflection layer on the concavo-convex pattern, it is possible to prevent a loss in light amount resulting from reflection of the hologram recording/reproducing light on the concavo-convex surface and exposure of the hologram recording layer to reflected light on the concavo-convex surface.

For the recording medium described above, it is preferable that the reflection layer is formed at a position in a range of 0.55 mm to 0.65 mm both inclusive or a position in a range of 1.1 mm to 1.3 mm both inclusive from a surface of one side of the hologram recording medium. According to this configuration, it is possible to reproduce information recorded in the concavo-convex pattern even by a conventional player for a CD, a DVD, or the like.

Further, for the recording medium described above, it is preferable that the hologram recording layer is held between two substrates, and at least one of the substrates contains a material that absorbs light having a shorter wavelength than the hologram recording/reproducing light. According to this configuration, not only can weather resistance be improved, but also occurrence of a change in shape induced by exposure to light can be suppressed.

Further, for the recording medium described above, it is preferable that the hologram recording medium has an approximate symmetric structure in a thickness direction about the hologram recording layer. According to this configuration, it is possible to lessen a change in shape of the hologram recording layer.

In another aspect of the invention, a hologram recording medium has a substrate and a hologram recording layer into or from which information is recorded or reproduced by a hologram, wherein a concavo-convex pattern detected by light having a longer wavelength than hologram recording/reproducing light is formed on a surface and/or in an inside of the hologram recording medium, and a pitch of the concavo-convex pattern is smaller than a distance over which the hologram recording medium and/or an optical system is moved to an adjacent hologram information page on a hologram medium surface during recording or reproduction of the hologram. According to this configuration, not only can the position information be detected by the concavo-convex pattern, but also exact position control can be performed on the medium surface, which makes it possible to reduce errors of the moving stroke during the hologram recording/reproduction. Hence, a large capacity and a higher degree of accuracy in recording/reproduction can be achieved at the same time.

In still another aspect of the invention, a hologram recording medium has a substrate and a hologram recording layer into or from which information is recorded or reproduced by a hologram, wherein the hologram recording layer has a hologram fixing portion in an inside thereof that transmits hologram recording/reproducing light and suppresses a change in shape of the hologram recording layer. According to this configuration, even in a case where the hologram recording layer is made of a material that readily undergoes a change in shape in response to an environmental change or under the recording conditions, a shift of the hologram recording layer can be lessened, which enables to perform hologram recording/reproduction at a higher degree of accuracy.

Also, for the recording medium described above, it is preferable that the hologram fixing portion has a layer structure. According to this configuration, it is possible to further lessen the change in shape of the hologram recording layer.

Further, for the recording medium described above, it is preferable that the hologram recording layer is held between two opposing substrates. According to this configuration, because the hologram recording layer is held between two substrates, the change in shape of the hologram recording layer can be lessened further.

Also, for the recording medium described above, it is preferable that the hologram fixing portion has a layer structure, and the hologram recording medium has an approximate symmetric structure in a thickness direction about the hologram fixing portion. According to this configuration, the change in shape of the hologram recording medium can be suppressed noticeably.

Also, for the recording medium described above, it is preferable that the hologram fixing portion is made of at least one kind selected from the group of a resin material, a glass material, and hologram media. According to this configuration, a shift caused by the change in shape can be lessened without making a loss in light amount of the hologram recording/reproducing light. Also, by using the hologram media in the hologram fixing portion, a difference in refractive index from the hologram fixing portion can be smaller.

Also, for the recording medium described above, it is preferable that a concavo-convex pattern is formed inside the hologram recording medium, and the concavo-convex pattern has a reflection layer that transmits the hologram recording/reproducing light and reflects light having a longer wavelength than the hologram recording/reproducing light. According to this configuration, position control of the hologram recording layer can be performed at a higher degree of accuracy.

Also, for the recording medium described above, it is preferable that the concavo-convex pattern is formed inside the substrate. According to this configuration, it is possible to prevent a phase shift of the hologram recording/reproducing light.

Also, for the recording medium described above, it is preferable that the hologram fixing portion has a layer structure and the concavo-convex pattern is formed inside the hologram fixing portion. According to this configuration, because the concavo-convex pattern is formed inside the hologram fixing portion, not only can a change in shape of the hologram recording layer be suppressed, but also a shift between the hologram recording layer and the hologram recording portion can be lessened even when the change in shape occurs. It is thus possible to detect the recording/reproduction position by the concavo-convex pattern at a higher degree of accuracy.

Also, for the recording medium described above, it is preferable that the reflection layer is formed at a position in a range of 0.55 mm to 0.65 mm both inclusive or a position in a range of 1.1 mm to 1.3 mm both inclusive from a surface of one side of the hologram recording medium. According to this configuration, it is possible to reproduce information recorded in the concave-convex pattern even by a conventional player for a CD, a DVD, or the like.

Also, for the recording medium described above, it is preferable that position information controlling recording/reproduction of information by a hologram and contents information of the hologram recording medium are recorded in the concavo-convex pattern. According to this configuration, by reading the concavo-convex pattern, the contents information, such as the index information, of the hologram recording medium can be confirmed even with the use of a conventional player.

Also, for the recording medium described above, it is preferable that the substrate contains a material that absorbs light having a shorter wavelength than the hologram recording/reproducing light. According to this configuration, not only can the weather resistance be improved, but also the occurrence of a change in shape induced by exposure to light can be suppressed.

Also, for the recording medium described above, it is preferable that a pitch of the concavo-convex pattern is smaller than a distance over which the hologram recording medium and/or an optical system is moved to an adjacent hologram information page on a medium surface of the hologram recording medium during recording or reproduction of the hologram. According to this configuration, detection of the position information using the concavo-convex pattern allows exact position control on the medium surface, which makes it possible to reduce errors of the moving stroke during the hologram recording/reproduction. Hence, a large capacity and a higher degree of accuracy in recording/reproduction can be achieved at the same time.

In still another aspect of the invention, a hologram recording medium has a substrate and a hologram recording layer into or from which information is recorded or reproduced by a hologram, wherein a concavo-convex pattern detected by light having a longer wavelength than hologram recording/reproducing light is formed inside the hologram recording medium, and position information controlling recording or reproduction of information by a hologram and contents information of the hologram recording medium are recorded in the concavo-convex pattern. According to this configuration, it is possible to reproduce the contents information recorded in the concave-convex pattern even by a conventional player for a CD, a DVD, or the like.

Further, in still another aspect of the invention, a hologram recording/reproduction device records or reproduces information by a hologram into or from a hologram recording medium having a concavo-convex pattern in an inside thereof, and comprises: a first light source that emits hologram recording/reproducing light; a second light source that emits position detecting light having a longer wavelength than the hologram recording/reproducing light; and a detection portion that reproduces position information used for recording/reproduction of a hologram and contents information recorded in the concavo-convex pattern by detecting reflected light of the position detecting light emitted from the second light source and collected on the concavo-convex pattern. According to this configuration, it is possible to reproduce a signal from a disc in compliance with the CD standards and the DVD standards in the same manner as in reproducing a contents information signal of the hologram recording medium.

### INDUSTRIAL APPLICABILITY

The hologram recording medium and the hologram recording/reproduction device of the invention can be used for a medium and a device for recording/reproducing a large capacity of information using the holographic technique.

1. A hologram recording medium having a substrate and a hologram recording layer into or from which information is recorded or reproduced by a hologram, characterized in that:
a concavo-convex pattern is formed inside the hologram recording medium; and
the concavo-convex pattern has a reflection layer that transmits hologram recording/reproducing light and reflects light having a longer wavelength than the hologram recording/reproducing light.

2. The hologram recording medium according to claim 1, wherein:
the concavo-convex pattern is formed at a position in a range of 0.55 mm to 0.65 mm both inclusive or a position in a range of 1.1 mm to 1.3 mm both inclusive from a surface of one side of the hologram recording medium.

3. The hologram recording medium according to claim 1, wherein:
the hologram recording layer is held between two substrates, and at least one of the substrates contains a material that absorbs light having a shorter wavelength than the hologram recording/reproducing light.

4. The hologram recording medium according to claim 1, wherein:
the hologram recording medium has an approximate symmetric structure in a thickness direction about the hologram recording layer.

5. A hologram recording medium having a substrate and a hologram recording layer into or from which information is recorded or reproduced by a hologram, characterized in that:
a concavo-convex pattern detected by light having a longer wavelength than hologram recording/reproducing light is formed on a surface and/or in an inside of the hologram recording medium; and
a pitch of the concavo-convex pattern is smaller than a distance over which the hologram recording medium and/or an optical system is moved to an adjacent hologram information page on a medium surface of the hologram recording medium during recording or reproduction of the hologram.

6. A hologram recording medium having a substrate and a hologram recording layer into or from which information is recorded or reproduced by a hologram, characterized in that:
the hologram recording layer has a hologram fixing portion in an inside thereof that transmits hologram recording/reproducing light and suppresses a change in shape of the hologram recording layer.

7. The hologram recording medium according to claim 6, wherein:
the hologram fixing portion has a layer structure.

8. The hologram recording medium according to claim 6, wherein:
the hologram recording layer is held between two opposing substrates.

9. The hologram recording medium according to claim 8, wherein:
the hologram fixing portion has a layer structure, and the hologram recording medium has an approximate symmetric structure in a thickness direction about the hologram fixing portion.

10. The hologram recording medium according to claim 6, wherein:
the hologram fixing portion is made of at least one kind selected from the group of a resin material, a glass material, and hologram media.

11. The hologram recording medium according to claim 6, wherein:
a concavo-convex pattern is formed inside the hologram recording medium, and the concavo-convex pattern has a reflection layer that transmits the hologram recording/reproducing light and reflects light having a longer wavelength than the hologram recording/reproducing light.

12. The hologram recording medium according to claim 11, wherein:
the concavo-convex pattern is formed inside the substrate.

13. The hologram recording medium according to claim 11, wherein:
the hologram fixing portion has a layer structure and the concavo-convex pattern is formed inside the hologram fixing portion.

14. The hologram recording medium according to claim 11, wherein:
the concavo-convex pattern is formed at a position in a range of 0.55 mm to 0.65 mm both inclusive or a position in a range of 1.1 mm to 1.3 mm both inclusive from a surface of one side of the hologram recording medium.

15. The hologram recording medium according to claim 11, wherein:
position information and contents information are recorded in the concavo-convex pattern.

16. The hologram recording medium according to claim 11, wherein:
a pitch of the concavo-convex pattern is smaller than a distance over which the hologram recording medium and/or an optical system is moved to an adjacent hologram information page on a medium surface of the hologram recording medium during recording or reproduction of the hologram.

17. The hologram recording medium according to claim 6, wherein:
the substrate contains a material that absorbs light having a shorter wavelength than the hologram recording/reproducing light.

18. A hologram recording medium having a substrate and a hologram recording layer into or from which information is recorded or reproduced by a hologram, characterized in that:
a concavo-convex pattern detected by light having a longer wavelength than hologram recording/reproducing light is formed inside the hologram recording medium; and
position information and contents information are recorded in the concavo-convex pattern.

19. A hologram recording/reproduction device that records or reproduces information by a hologram into or from a hologram recording medium having a concavo-convex pattern in an inside thereof, characterized by comprising:
a first light source that emits hologram recording/reproducing light;
a second light source that emits position detecting light having a longer wavelength than the hologram recording/reproducing light; and
a detection portion that reproduces position information and contents information recorded in the concavo-convex pattern by detecting reflected light of the position detecting light emitted from the second light source and collected on the concavo-convex pattern.
